(19) United States
(12) Patent Application Publication
(10) Pub. No.: US 2019/0028788 A1
(43) Pub. Date: Jan. 24, 2019

(54) Microphone Mount For A Speaker Cabinet

(71) Applicant: Maxwell Philip Ducker, Melbourne (AU)

(72) Inventor: Maxwell Philip Ducker, Melbourne (AU)

(21) Appl. No.: 15/652,239

(22) Filed: Jul. 18, 2017

(51) Int. Cl. H04R 1/08; H04R 1/32

(52) U.S. Cl. CPC H04R 1/083; H04R 1/326

(57) ABSTRACT

A microphone apparatus for mounting a microphone adjacent to a loudspeaker housed in a loudspeaker cabinet is defined by, an “L” shaped body with an adjustable foot that slides in a longitudinal direction along a channel strip to bridge a desired distance between the speaker cabinet and an opposing surface to achieve a wedge and secure mount. A positioning arm is fixed to the face of the “L” shape body and used to position the microphone to the desired distance of the loud speaker in the loudspeaker cabinet.

### FIELD OF THE INVENTION

This invention relates to devices used by Sound engineers, Production companies and musicians to mount microphones to other equipment, more specifically to an apparatus for mounting a microphone to a loudspeaker cabinet.

### BACKGROUND OF THE INVENTION

Sound engineers, musicians and others involved in the music industry often use microphones to amplify sound from loud speakers. With a multitude of varying sized loudspeaker cabinets and microphones available, typically a microphone is held in a clip attached to a tripod stand. The tripod is generally positioned on the floor in front of the loudspeaker cabinet and angled to the desired distance from of the loudspeaker.

Tripods and other microphone stands utilize legs or weighted bases that can present hazards to performers and are easily knocked out of place when performers need access to their loudspeaker or amplifier or during a performance for example. Either loudspeaker accessibility or cramped performance conditions can prevent ideal microphone placement, which in turn will result in degraded sound quality. It would therefore be desirable to provide an apparatus, which alleviates or at least ameliorates the above problems.

### SUMMARY OF THE INVENTION

In a first aspect, the present invention provides an apparatus for mounting a microphone to a loudspeaker cabinet having a loudspeaker, including: a body having an adjustable foot that slides in a longitudinal motion along a channel strip in the body to provide a wedge between the loudspeaker cabinet and an opposing surface thereby securing the apparatus in place; the apparatus further including a positioning arm at one end of the body to receive and position a microphone.

Advantageously, the present invention provides a microphone mounting apparatus that c is designed to adapt to a loudspeaker cabinet so that a microphone is secured at a desired distance and position to the loudspeakers. Advantageously floor “real-estate” and performance area is maximized while allowing performers to perform closer to their loudspeaker without hazard or accidental microphone movement and sound degradation.

Preferably, the positioning arm is a flexible arm, and in use is adapted to position the microphone to a desired distance from the loudspeaker of the loudspeaker cabinet. It will be appreciated that any arm could be used, for example a gooseneck arm could be used. The arm need not be flexible—a fixed arm could be provided.

The body is preferably substantially “L” shaped but need not be. It will be appreciated that the “L” shaped body could have an alternate body shape, for example an upside down “T” shaped body or the like.

The apparatus of the present invention provides a body with an adjustable foot that slides in a longitudinal motion along a channel strip to bridge a desired distance between, for example, a loudspeaker cabinet and an opposing surface to achieve a wedge and secure mount. In operation, a body with an adjustable foot that slides in a longitudinal motion along a channel strip in the body bridges a desired distance between a loudspeaker cabinet and an opposing surface to achieve a wedge and secure mount of the apparatus. A positioning arm is fixed to a face of the body and used to position the microphone to the desired distance from the loudspeaker. It will be appreciated that the “L” shaped body could have an alternate body shape, for example an upside down “T” shaped body or similar.

The positioning arm (e.g. a gooseneck arm or the like) may then be positioned to achieve the desired distance to the loudspeaker. It will also be appreciated the gooseneck could be substituted for an alternate positioning arm, for example a fixed metal bar. It will be appreciated that the fastener used to secure the positioning arm to the body could be substituted for any number of fixtures, for example a hex bolt or welded joint or the like.

Preferably, the opposing surface is one of: a surface beneath the loudspeaker cabinet (such as the floor or a stage), or the bottom surface of a loudspeaker cabinet. It will be appreciated that the opposing surface may be one of: a bottom surface of an amplifier head, or the top surface of a loudspeaker cabinet. That is to say that the apparatus may be provided between a loudspeaker cabinet and the floor, or between a loudspeaker cabinet and an amplifier positioned on top of the loudspeaker cabinet.

Preferably, the body has a vertical channel cut to allow a guide to travel in a longitudinal motion without deviating off its path. The guide may be threaded and the threaded guide may include a fastener which may be rotated to loosen or tighten and secure the adjustable foot at the desired height along the channel strip. It will be appreciated that the fastener could be any number of different fixtures, for example a wing nut or clamping knob or the like.

The adjustable foot that traverses the channel strip preferably has two 90 degree folds that run either side of the out outer edges of the body, allowing extra stability and hindering rotation of the adjustable foot. Preferably, the adjustable foot includes a material that lines the surface of the adjustable foot that comes into contact with the loudspeaker cabinet. The material lining the adjustable foot preferably includes sound absorption properties that hinder unwanted sonic rumble in the form of audio frequencies traveling from the loudspeaker or stage floor through to the mount and on to be picked up by the microphone. The material lining the adjustable foot preferably also has gripping properties enabling a more secure mount to the loudspeaker cabinet.

The positioning arm may be connected to the body by a fastener that joins it to a face of the body. The fastener attaching the positioning arm may include a spring washer between a face of the body and the positioning arm to provide a secure attachment.

Preferably, the positioning arm has a standard thread that provides the ability to attach any microphone housing of choice. The microphone housing attached may fit any variety of different microphone designs. It will be appreciated that the microphone clip attached to the positioning arm for holding a microphone could be substituted for an alternate microphone housing to contain the many varieties of microphones available, for example a cradle or basket housing.

The adjustable foot and body in operation, bridges a desired gap between two opposing surfaces to form a wedge between the two opposing surfaces. The adjustable foot is utilized to secure a mount and achieve a number of positions in which the apparatus can be secured to the loudspeaker cabinet.

The apparatus may be attached to a loudspeaker cabinet utilizing the gap between the bottom surface of the loudspeaker cabinet and the opposing floor surface to wedge between. In an alternative, the apparatus when rotated through 180 degrees, utilizes a gap between the amplifier bottom surface and the top surface of the loudspeaker cabinet to mount the apparatus. In a further alternative, the apparatus is rotated 180 degrees and fixed upside down to a handle strap of a loudspeaker cabinet utilizing the longitudinal edges of the strap handle to provide a clamp. In another alternative, the apparatus is secured to a loudspeaker cabinet by retracting the adjustable foot and placing it under the bottom lip of the loudspeaker cabinet allowing the weight of the cabinet to hold the apparatus in place.

In a second aspect, the present invention provides a method for mounting a microphone to a loudspeaker cabinet with a separate amplifier including: a) providing the apparatus for mounting the microphone of the first aspect; b) holding the positioning arm perpendicular to the loudspeaker and sliding the body and adjustable foot under the bottom of the loudspeaker cabinet; c) adjusting the adjustable foot upwards in a longitudinal direction along the channel slot to meet a bottom surface of the loudspeaker cabinet; and d) tightening the fastener to secure the adjustable foot in place.

The method may further include the steps of positioning the microphone via the positioning arm to the desired distance to the loudspeaker housed in the loudspeaker cabinet.

In a third aspect, the present invention provides a method for mounting a microphone to a loudspeaker cabinet with a separate amplifier including: a) providing the apparatus for mounting the microphone of the first aspect; b) providing the positioning arm perpendicular to the loudspeaker cabinet and rotating the apparatus 180 degrees; c) sliding the body and adjustable foot between a top surface of the loudspeaker cabinet and a bottom surface of the amplifier head; d) adjusting the adjustable foot in a longitudinal direction along the channel slot to meet the top surface of the loudspeaker cabinet; and e) tightening the fastener to secure the adjustable foot in place. The method may further include the steps of positioning the microphone via the positioning arm to the desired distance to the loudspeaker housed in the loudspeaker cabinet.

In a fourth aspect, the present invention provides a method for mounting a microphone to a loudspeaker cabinet with a inbuilt amplifier including: a) providing the apparatus for mounting the microphone of the first aspect; b) providing the positioning arm perpendicular to the loudspeaker; c) tilting the loudspeaker cabinet backwards; d) sliding the body and retracted adjustable foot under the bottom of the loudspeaker cabinet; e) lowering the loudspeaker cabinet onto the top of the adjustable foot; and f) positioning the microphone with the positioning arm to the desired distance from the loudspeaker housed in the loudspeaker cabinet.

In a fourth aspect, the present invention provides a method for mounting a microphone to a loudspeaker cabinet with a inbuilt amplifier including: a) providing the apparatus for mounting the microphone of the first aspect; b) positioning the apparatus so a face of the body is parallel to the top surface of the loudspeaker cabinet and the positioning arm is perpendicular to the loudspeaker; c) tilting and sliding the body under a strap handle of the loudspeaker cabinet such that the top surface of the base abuts the back edge of the strap handle; d) positioning the adjustable foot along the channel slot so the bottom surface of the adjustable foot aligns with the front edge of the strap; and e) tightening the fastener to secure the adjustable foot in place; f) position the microphone with the positioning arm to the desired distance from the loudspeaker housed in the loudspeaker cabinet.

### BRIEF DESCRIPTION OF THE DRAWINGS

The invention will be better understood and its numerous objects and advantages will be apparent by reference to the following detailed description of the invention when taken in conjunction with the following drawings.

FIG. 1 is a front view of the apparatus according to the present invention;

FIG. 2 is a symmetric view of the apparatus according to the present invention;

FIG. 3 is a side view of the apparatus according to the present invention;

FIG. 4 is a rear view of the apparatus according to the present invention;

FIG. 5 is a side view of the apparatus according to the present invention attached to a loudspeaker cabinet, in a first embodiment;

FIG. 6 is a side view of the apparatus according to the present invention attached to a loudspeaker cabinet, in a second embodiment;

FIG. 7 is a rear view of the apparatus according to the present invention attached to a loudspeaker cabinet, in a third embodiment;

FIG. 8 is a rear view of the apparatus according to the present invention attached to a loudspeaker cabinet, in a forth embodiment;

FIG. 9 is a side view of the apparatus according to the present invention attached to a loudspeaker cabinet, in a fifth embodiment;

FIG. 10 is a side view of the apparatus according to the present invention attached to a tilted loudspeaker cabinet, in a sixth embodiment.

### DETAILED DESCRIPTION OF THE PREFERRED EMBODIMENTS

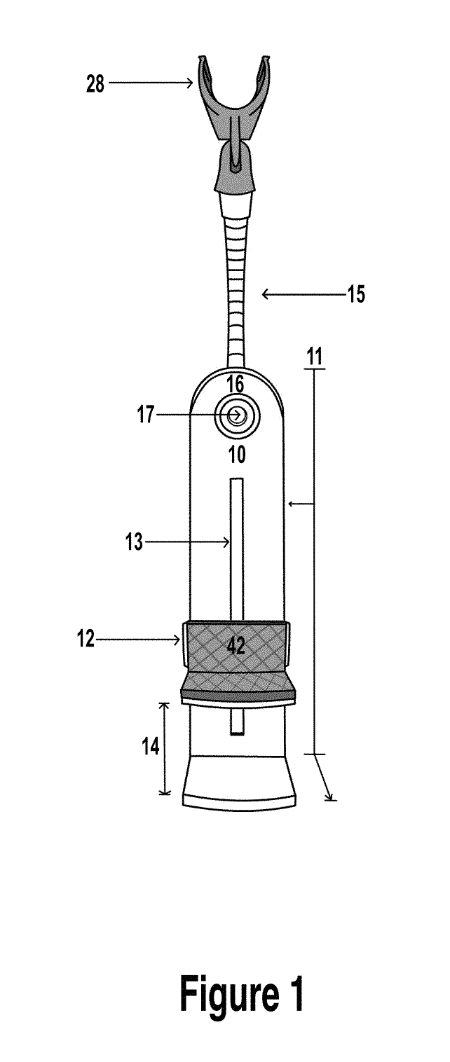

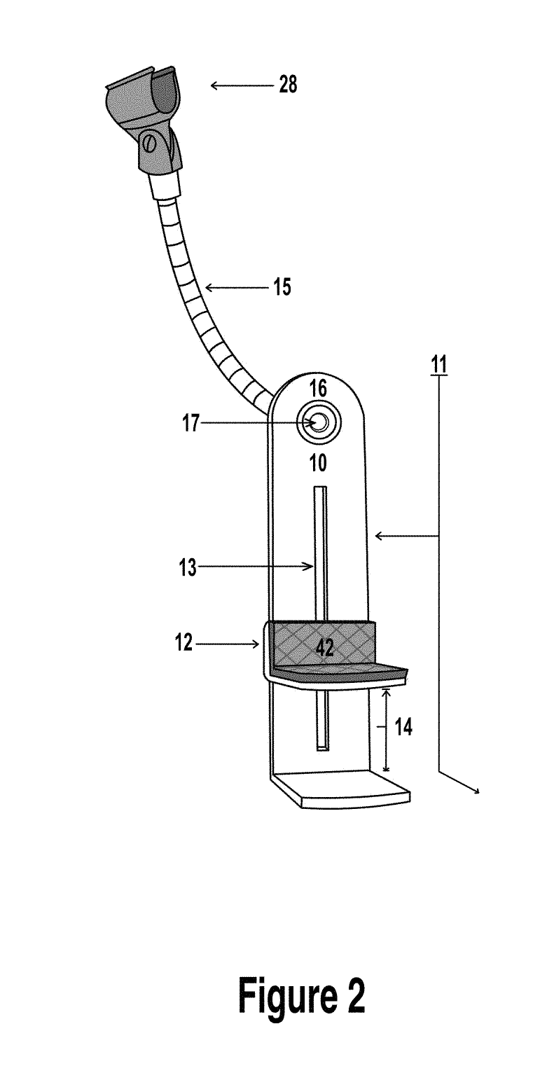

An apparatus 10 according to the present invention will now be described with reference to the drawings. With reference to FIG. 1 and FIG. 2, the apparatus 10 includes an “L” shaped body 11 with a separate adjustable foot 12 that slides in a longitudinal motion along a channel strip 13 to bridge a desired distance 14 between the loudspeaker cabinet [NOT SHOWN] and an opposing surface [NOT SHOWN] to achieve a wedge and secure mount. A positioning arm 15 is attached to the body 11 and is used to position the microphone housing 28 and microphone to a desired distance from a loudspeaker. The positioning arm 15 is fixed to the top inside face 16 of the body 11 with a fastener 17. A piece of resilient material 42 with high memory properties lines the contact area of the adjustable foot 12 to achieve a secure mount and minimize sonic artifacts inherently generated by the loudspeaker or floor that apparatus 10 is in contact with.

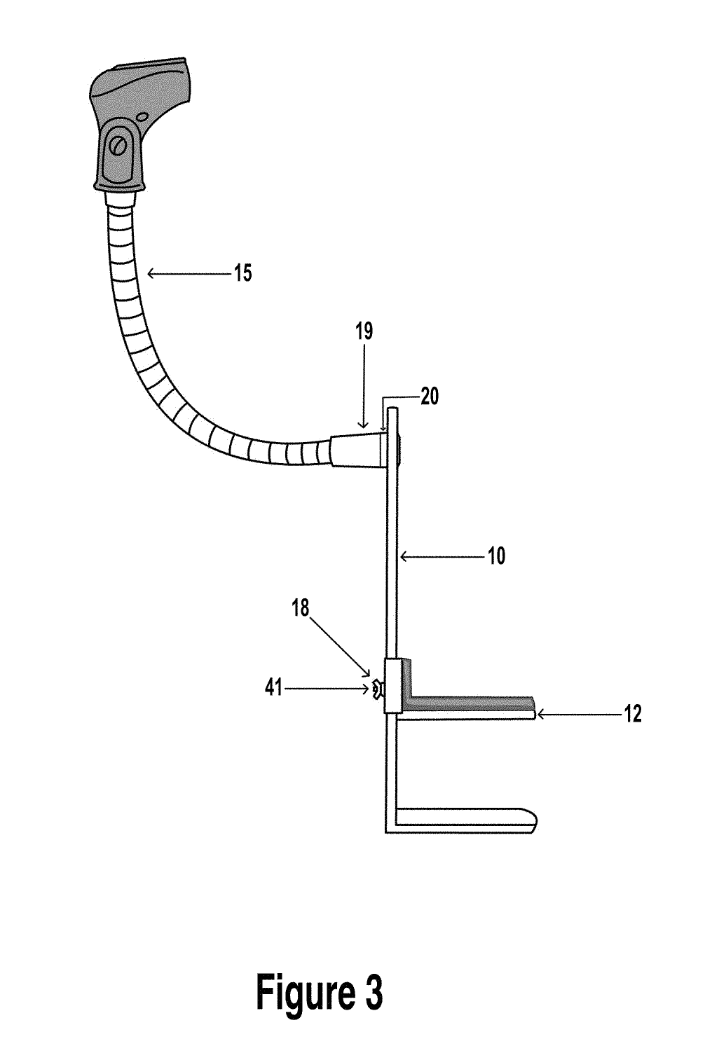

FIG. 3 is a side view of the apparatus 10 and further shows the fastener 18 used to secure a threaded guide 41 that is attached to the adjustable foot 12 at a desired height to achieve a secure mount to the loudspeaker cabinet [NOT SHOWN]. Positioning arm 15, positioning arm base 19 and spring washer 20 are provided to reinforce the binding integrity of the positioning arm 15 to the body 11.

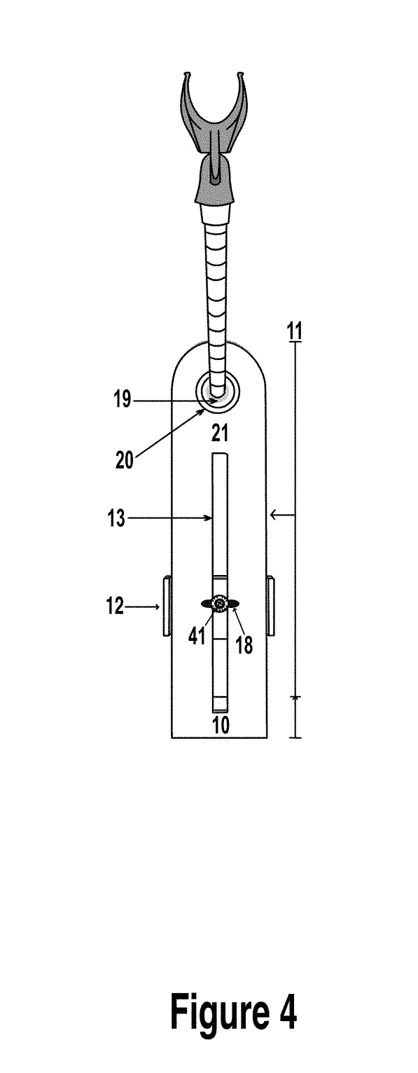

FIG. 4 is a rear view of the apparatus 10, showing the guide 41 attached to the adjustable foot 12 that runs longitudinally along the inside of the channel strip 13.

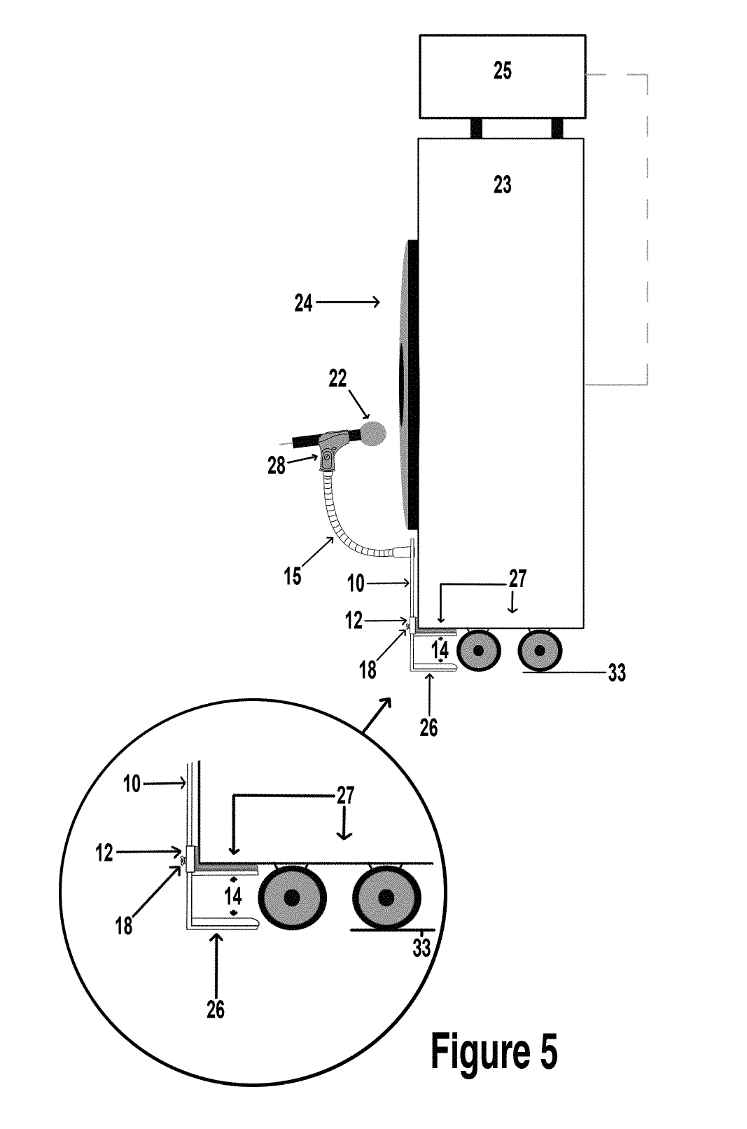

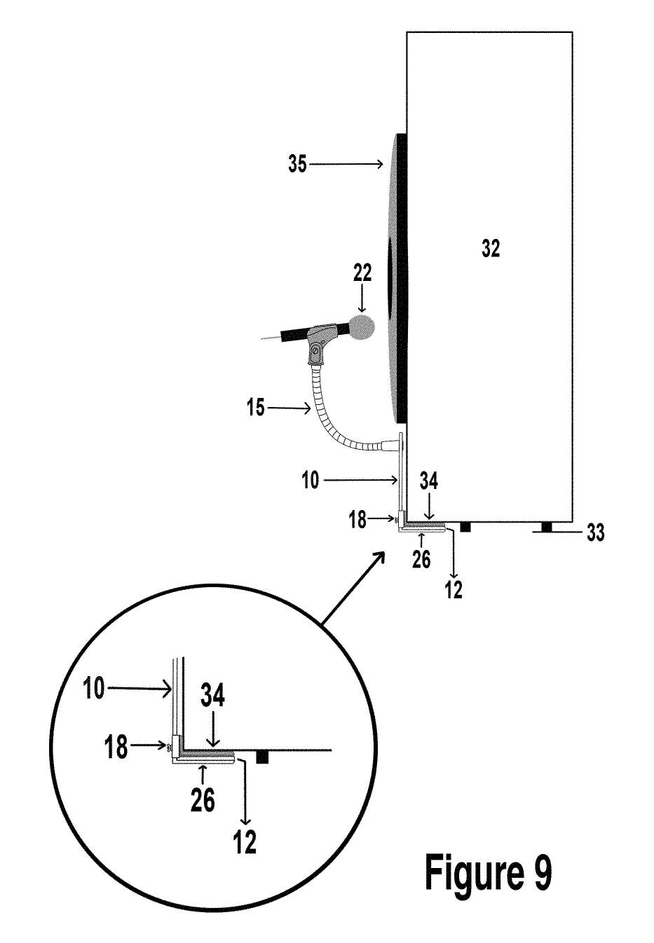

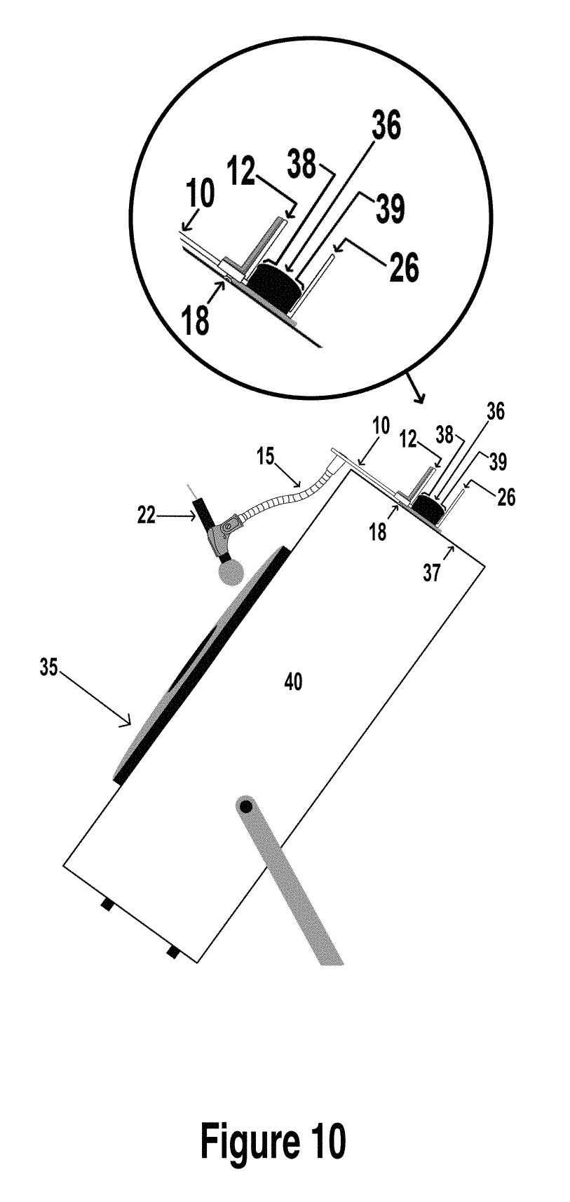

FIG. 5 through 10 shows the apparatus 10 used to position a microphone 22 adjacent to a loudspeaker 24, 35 housed in a cabinet 23, 32, 40. It will be understood that cabinet 23, 32, 40 houses one or more loudspeakers 24, 35 which are not shown in FIG. 1, 2, 3 or FIG. 4, but which are positioned in a conventional manner behind a speaker grill. There are two basic types of cabinets, those having amplifiers housed in the loudspeaker cabinet 32, 40 along with the loudspeakers 35 (refer to FIG. 9 and FIG. 10), and those 23 having separate amplifiers 25 (refer to FIG. 5, 6, 7, 8).

Within those two general categories of loudspeaker cabinets, there are innumerable shapes for the loudspeaker cabinet housings. The loudspeaker cabinet 23 shown in FIG. 5 utilizes a typical box-shaped loudspeaker cabinet. Advantageously, the apparatus 10 is designed to adapt to most commercially available loudspeaker cabinets, regardless of the configuration of the particular loudspeaker cabinet housing used. The apparatus may be used with wireless microphones but more typically is used with microphones that use standard cabling.

The apparatus 10 utilises a microphone housing 28 to cradle the microphone 22 while the positioning arm 15 is positioned to the desired distance from the loudspeaker 24, 35 housed in a loudspeaker cabinet 23 FIG. 5, 6, 7, 8 and the loudspeaker cabinet 32 FIG. 9 and also the loudspeaker cabinet 40 FIG. 10. It will be appreciated that the manner in which microphone 22 is attached to the positioning arm 15 may be carried out in any suitable way. There are numerous equivalent housing structures that may be used in place of these components to cradle the numerous microphone varieties available, for example, a shock mount cradle housing used to hold a larger condenser microphone.

With reference now to FIG. 5, 6, 7, 8, 9 and FIG. 10, the present invention can be mounted a number of ways to the loudspeaker cabinet 23, 32, 40.

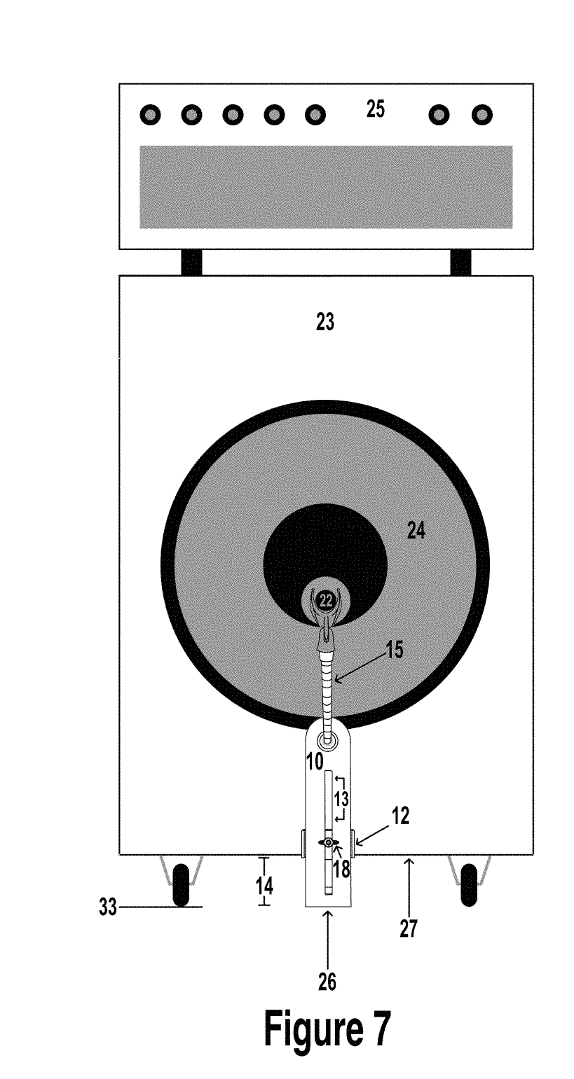

FIG. 5 and FIG. 7 show the apparatus 10 mounted to the loudspeaker cabinet 23 by holding the positioning arm 15 perpendicular with one hand and sliding the base 26 and retracted adjustable foot 12 under the bottom front lip 27 of the loudspeaker cabinet 23. By adjusting the adjustable foot 12 upwards in a longitudinal direction along the channel slot 13 towards the bottom surface 27 of the loudspeaker cabinet 23 to reach the desired height needed to bridge the gap 14 between the floor surface 33 and the adjacent surface 27 of the loudspeaker cabinet 23. Once the correct bridging height has been provided, the fastener 18 may be tightened and checked that a secure mount has been achieved. The microphone 22 is then positioned via the positioning arm 15 to the desired distance to the loudspeaker 24 housed in the loudspeaker cabinet 23.

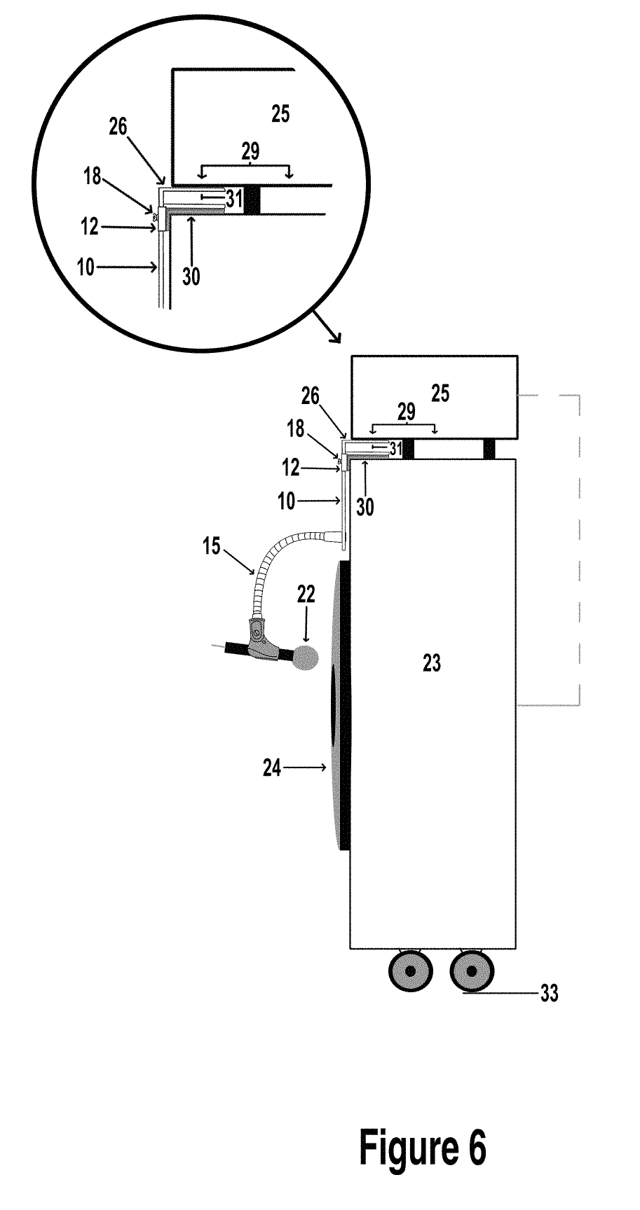

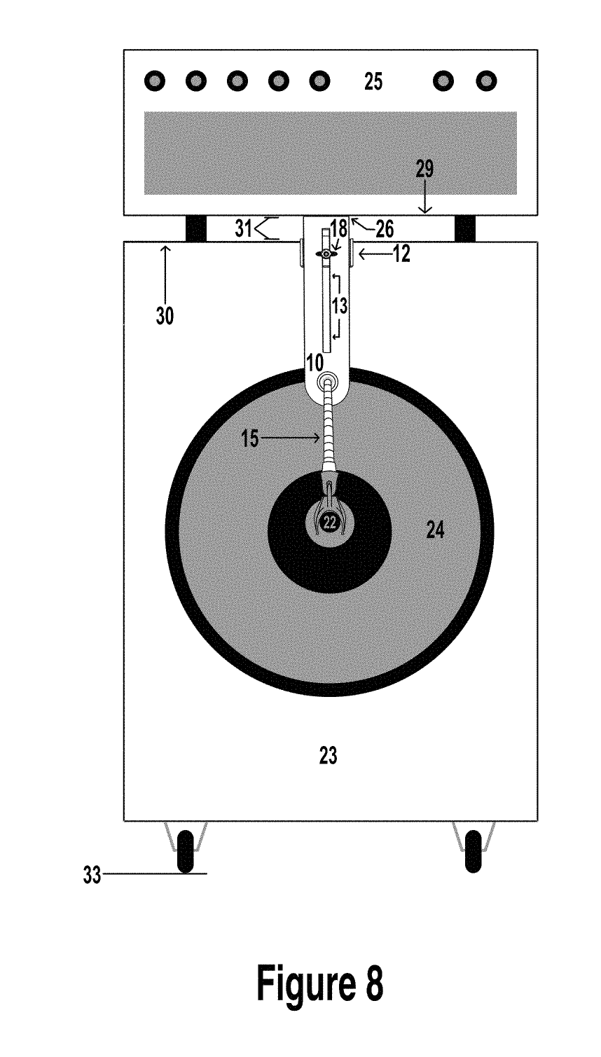

FIG. 6 and FIG. 8, show the apparatus 10 mounted to the loudspeaker cabinet 23 upside down, by rotating the apparatus 180 degrees so the base 26 is facing the ceiling. The base 26 and retracted adjustable foot 12 may be slid between the bottom front lip of the amplifier 29 and the top surface of the loudspeaker cabinet 30. The adjustable foot 12 is adjusted downwards in a longitudinal direction along the channel slot 13 towards the top surface of the loudspeaker cabinet 30 to reach the desired height needed to bridge the gap 31 between the amplifier bottom surface 29 and the adjacent surface of the loudspeaker cabinet 30. Once the correct bridging height has been provided, the fastener 18 may be tightened and check a secure mount has been achieved. The microphone 22 may then be positioned with the positioning arm 15 to the desired distance from the loudspeaker 24 housed in the loudspeaker cabinet 23.

FIG. 9 illustrates mounting the apparatus 10 to a loudspeaker cabinet 32 that has an inbuilt amplifier housed within the loudspeaker cabinet 32. Those in the music industry refer to this variety of loudspeaker cabinet 32 FIGS. 9 and 40 FIG. 10, as a Combo amp. To achieve a secure mount with the apparatus 10, the adjustable foot 12 is retracted to the lowest position so the bottom surface of the adjustable foot 12 is flush with the top surface of base 26. When the desired bridging height is achieved, fastener 18 is tightened to secure the adjustable foot 12. The positioning arm 15 is then provided perpendicular to the loudspeaker 35 and the loudspeaker cabinet 40 is tilted on to its back edge with one hand and with a spare hand the base 26 is slid with retracted adjustable foot 12 under the bottom front lip of the loudspeaker cabinet 32. The loudspeaker cabinet 32 may then be lowered onto the top of the adjustable foot 12. A check may then be made that a secure mount has been achieved and the microphone 22 may be positioned with the positioning arm 15 to the desired distance to the loudspeaker 35 housed in the loudspeaker cabinet 32.

FIG. 10 illustrates the apparatus 10 with a tilted loudspeaker cabinet 40 that has an inbuilt amplifier housed within the loudspeaker cabinet 40. Those in the music industry refer to this variety of loudspeaker cabinet 40 and FIG. 9, 32 as a Combo amp. To achieve a secure mount, the apparatus 10 is laid with the rear face 21 [NOT SHOWN] parallel to the top surface 37 of the loudspeaker cabinet 40. The base 26 is slid under the strap handle 36 of the loudspeaker cabinet 40 so the top surface of the base 26 lines up against the back edge of the strap handle 39. The adjustable foot 12 is then adjusted along the channel slot 13 [NOT SHOWN] so the bottom surface of the adjustable foot 12 aligns with the front edge 38 of the strap handle 36. The fastener 18 may then be tightened to secure the adjustable foot 12 and a check for a secure mount may then be carried out. The microphone 22 may then be positioned with the positioning arm 15 to the desired distance to the loudspeaker 35 housed in the loudspeaker cabinet 40.

It will be appreciated by those of skill in the art that the microphone mounts described above may be modified in certain equivalent respects without departing from the scope of the invention. As one example, the positioning arm 15 may be substituted for another means of positioning the microphone 22. The Microphone housing 28 may take any form and there are numerous equivalent housing structures that may be used in place of these components to cradle the numerous microphone varieties available. While the present invention has been described in terms of a preferred embodiment, it will be appreciated by one of ordinary skill that the spirit and scope of the invention is not limited to those embodiments.

1. An apparatus for mounting a microphone to a loudspeaker cabinet having a loudspeaker, including:
a body having an adjustable foot that slides in a longitudinal motion along a channel strip in the body to provide a wedge between the loudspeaker cabinet and an opposing surface thereby securing the apparatus in place; the apparatus further including a positioning arm at one end of the body to receive and position a microphone.

2. The apparatus according to claim 1 wherein the positioning arm is a flexible arm and in use is adapted to position the microphone to a desired distance from the loudspeaker of the loudspeaker cabinet.

3. The apparatus according to claim 1, wherein the body is substantially “L” shaped.

4. The apparatus according to claim 1, wherein the body is “T” shaped.

5. The apparatus according to claim 1, wherein the opposing surface is one of: a surface beneath the loudspeaker cabinet, or the bottom surface of a loudspeaker cabinet.

6. The apparatus according to claim 1, wherein the opposing surface is one of: a bottom surface of an amplifier head, or the top surface of a loudspeaker cabinet.

7. The apparatus according to claim 1, wherein the body has a vertical channel cut to allow a guide to travel in a longitudinal motion without deviating off its path.

8. The apparatus according to claim 7, wherein the guide is threaded.

9. The apparatus according to claim 8, wherein the threaded guide has a fastener which may be rotated to loosen or tighten and secure the adjustable foot at the desired height along the channel strip.

10. The apparatus according to claim 9, wherein the adjustable foot that traverses the channel strip has two 90 degree folds that run either side of the body outer edges, allowing extra stability and hindering rotation of the adjustable foot.

11. The apparatus according to claim 9, wherein the adjustable foot that traverses the channel strip includes a material that lines the surface of the adjustable foot that comes into contact with the loudspeaker cabinet.

12. The apparatus according to claim 11, wherein the material lining the adjustable foot includes sound absorption properties that hinder unwanted sonic rumble in the form of audio frequencies traveling from the loudspeaker or stage floor through to the mount and on to be picked up by the microphone.

13. The apparatus according to claim 12, wherein the material lining the adjustable foot has also gripping properties enabling a more secure mount to the loudspeaker cabinet.

14. The apparatus according to claim 2, wherein the flexible arm is connected by a fastener, that joins it to a face of the body.

15. The apparatus according to claim 14, wherein the fastener attaching the positioning arm has a spring washer between a face of the body and the positioning arm to provide a secure attachment.

16. The apparatus according to claim 2, wherein the positioning arm has a standard thread that provides the ability to attach any microphone housing of choice.

17. The apparatus according to claim 16, wherein the microphone housing attached may fit any variety of different microphone designs.

18. The apparatus according to claim 11, wherein the adjustable foot and body bridges a desired gap between two opposing surfaces to form a wedge between the two opposing surfaces.

19. The apparatus according to claim 18, wherein the adjustable foot is utilized to secure a mount and achieve a number of positions in which the apparatus can be secured to the loudspeaker cabinet.

20. The apparatus according to claim 19, wherein the apparatus may be attached to a loudspeaker cabinet utilizing the gap between the bottom surface of the loudspeaker cabinet and the opposing floor surface to wedge between.

21. The apparatus according to claim 6 wherein the apparatus is attached upside down when rotated through 180 degrees utilizing a gap between the amplifier bottom surface and the top surface of the loudspeaker cabinet to mount the apparatus.

22. The apparatus according to claim 21, wherein the apparatus is rotated 180 degrees and fixed upside down to a handle strap of a loudspeaker cabinet utilizing the longitudinal edges of the strap handle to provide a clamp.

23. The apparatus according to claim 20, wherein the apparatus is secured to a loudspeaker cabinet by retracting the adjustable foot and placing it under the bottom lip of the loudspeaker cabinet allowing the weight of the loud speaker cabinet to hold the apparatus in place.

24. A method for mounting a microphone to a loudspeaker cabinet with a separate amplifier including:
a) providing the apparatus for mounting the microphone of claim 1:
b) holding the positioning arm perpendicular to the loudspeaker and sliding the body and retracted adjustable foot under the bottom of the loudspeaker cabinet;
c) adjusting the adjustable foot upwards in a longitudinal direction along the channel slot to meet a bottom surface of the loudspeaker cabinet;
d) tightening the fastener to secure the adjustable foot in place; and
e) positioning the microphone with the positioning arm to the desired distance from the loudspeaker housed in the loudspeaker cabinet.

25. The method of claim 24, further including the steps of positioning the microphone via the adjustable arm to the desired distance to the loudspeaker housed in the loudspeaker cabinet.

26. A method for mounting a microphone to a loudspeaker cabinet with a separate amplifier including:
a) providing the apparatus for mounting the microphone of the first aspect;
b) providing the positioning arm perpendicular to the loudspeaker cabinet and rotating the apparatus 180 degrees;
c) sliding the body and adjustable foot between a top surface of the loudspeaker cabinet and a bottom surface of the amplifier head;
d) adjusting the adjustable foot in a longitudinal direction along the channel slot to meet the top surface of the loudspeaker cabinet;
e) tightening the fastener to secure the adjustable foot in place; and
f) positioning the microphone with the positioning arm to the desired distance from the loudspeaker housed in the loudspeaker cabinet.

27. A method for mounting a microphone to a loudspeaker cabinet with a inbuilt amplifier including:
a) providing the apparatus for mounting the microphone of claim 1:
b) providing the positioning arm perpendicular to the loudspeaker,
c) tilting the loudspeaker cabinet backwards;
d) sliding the body and adjustable foot under the bottom of the loudspeaker cabinet;
e) lowering the loudspeaker cabinet onto the top of the adjustable foot; and
f) positioning the microphone with the positioning arm to the desired distance from the loudspeaker housed in the loudspeaker cabinet.

28. A method for mounting a microphone to a loudspeaker cabinet with a inbuilt amplifier including:
a) providing the apparatus for mounting the microphone of claim 1;
b) positioning the apparatus so the face of the body is parallel to the top surface of the loudspeaker cabinet and the positioning arm is perpendicular to the loudspeaker;
c) tilting and sliding the body under a strap handle of the loudspeaker cabinet such that the top surface of the base abuts the back edge of the strap handle;
d) positioning the adjustable foot along the channel slot so the bottom surface of the adjustable foot aligns with the front edge of the strap;
e) tightening the fastener to secure the adjustable foot in place; and
f) positioning the microphone with the positioning arm to the desired distance from the loudspeaker housed in the loudspeaker cabinet.
